(19) United States
(12) Patent Application Publication
(10) Pub. No.: US 2026/0138388 A1
(43) Pub. Date: May 21, 2026

(54) Recording Material Containing a Coated Polyester Film

(71) Applicant: Agfa-Gevaert NV, Mortsel (BE)

(72) Inventors: Hubertus Van Aert, Mortsel (BE); Jurgen Jung, Mortsel (BE); Dirk Quintens, Mortsel (BE); Stefaan Smet, Mortsel (BE)

(73) Assignee: Agfa-Gevaert NV, Mortsel (BE)

(21) Appl. No.: 19/121,870

(22) PCT Filed: Oct. 2, 2023
(86) PCT No.: PCT/EP2023/077206

§ 371 Date: Apr. 17, 2025

(30) Foreign Application Priority Data
Oct. 19, 2022 (EP) 22202381.4

(51) Int. Cl. B41M 5/50; B29C 55/14; C08J 5/18; C08J 7/04; C08J 7/043; C08J 7/044; C09D 7/42

(52) U.S. Cl. CPC B41M 5/508; B29C 55/14; C08J 5/18; C08J 7/0427; C08J 7/043; C08J 7/044; C09D 7/42; C08J 2367/02; C08J 2425/08; C08J 2427/04

(57) ABSTRACT

A recording material comprising a bi-axially stretched polyester containing film and a printable subbing layer formed on at least one surface of the film, the layer having a total coverage of 0.4 g/m² or more and the layer comprising a water insoluble Cl-containing polymer, a water insoluble non-Cl containing polymer and a water soluble polymer containing an anionic group. A method of producing the recording material is also provided. The recording material is suitable as printable synthetic paper.

### TECHNICAL FIELD

The present invention relates to a coated polyester film for the use as a printable synthetic paper and to a method of the production thereof.

### BACKGROUND ART

With the increasing capabilities of copiers, offset printers, inkjet printers and xerographic printers, such apparatuses are now used to issue paper materials for various applications and in various forms, e.g., printing of colour documents, photographs, images and issuing ledger sheets, posters, labels and vouchers in addition to printing and copying documents. As a result, the consumption of copy paper and printer paper in document printing, book printing, sign and display printing is increasing.

Mass consumption of paper including copy paper and printer paper is not desirable from the viewpoint of suppressing deforestation.

On the other hand, paper for specific imaging applications need to exhibit a high water-resistance, exhibit good scratch and abrasion resistance, exhibit good chemical resistance to acids and alkali's and need to be suitable for outside applications i.e. be resistant to UV-exposure and oxidation.

Accordingly, research has been conducted on synthetic paper made of polymers as a material completely substitutable for paper. For example, polypropylene synthetic paper is used in articles of daily use as disclosed in Japanese Patent Laid-Open No 10-204196 and white polyester films containing a polyester incompatible material are used for offset and xerographic printing as disclosed in EP 3071636 A or EP 2103736 A.

In the past, various problems and difficulties have been faced by those skilled in the art when attempting to apply graphics or lettering via offset printing, inkjet printing, xerographic printing onto white polyester films.

Polyester films are typically hydrophobic and therefore not readily receptive to many inks, pigments and toners. Consequently, in order to use white polyester films in printing applications, the films typically are coated with a printable layer. In the past, various different types of these layers have been suggested. For instance, PCT Publication No. WO94/13481 discloses a co-polyester film coated on one or both sides with vinyl acetate polymers.

Besides the image receptive function of the printable layer, this layer needs also to fulfil feedability requirements in printers in order to avoid transport issues of the media through the copier or printer.

Last but not least, the image recording layer must have the appearance of the surface of wood based paper in order to give the white polyester film the same ‘look and feel’ as uncoated wood based paper, which has a matt surface. A typical parameter to characterize the matt surface of copy paper is the measurement of specular gloss. Based on a standard test method for specular gloss, ASTM D 523, gloss is measured at 20°, 60° and 85° depending on the level of gloss. Surfaces start to appear matt when the gloss values at 20° and 60° are below 20. For uncoated matte papers, also the specular gloss at an angle of 85°, also called ‘sheen’, becomes very low: Typical copy papers show a gloss value of 5 or less.

The printable layer may be provided by in-line coating wherein this layer is applied during the film forming process of the white polyester film, or by off-line coating in which the white polyester film once produced is coated with the image recording layer in an additional step in the production process.

Patent application WO 2009/115416 and EP 2103736A, showed that for acceptable toner acceptance, the printable layers should have a thickness of at least 3 μm.

In earlier work, anti-static layers as printable layers for xerographic printing onto polyester substrates have layer thicknesses of less than 0.5 μm as described in US 2019/031774. However, these anti-static layers do not offer the desired low gloss and matt appearance of wood based printing or copying paper.

US2002/0009607 discloses the use of gel silica with a particle size of more than 1 μm to achieve gloss reduction.

In particular, the method wherein the printable layer is formed by in-line coating, is more preferable as this is a leaner production process and does not require an additional adhesion layer onto the white polyester film surface to assure a good adhesion of the printable layer.

In-line coating is a method in which coating is performed during the process of producing the polyester film, and more preferably is a method in which the coating is performed onto a mono-axially stretched film, e.g. stretched in the longitudinal direction or machine direction (MD). Such a method enables polyester film formation and printable layer formation to be simultaneously performed and is thus advantageous with respect to production cost.

By providing the printable layer on the polyester film before stretching, this layer is stretched together with the polyester film, thereby enabling the printable layer to be firmly adhered to the substrate film as disclosed in US 2019381774 A.

However, the stretching after coating decreases the thickness of the printable layer according to the stretch ratio, to such an extent that the smoothness of the underlying polyester film dominates. This results in a glossier image recording material wherein its surface appearance deviates from the typical wood based printing paper look. Also other surface properties such as roughness, blocking resistance, friction coefficient and feedability of the recording media are changed due to the increased smoothness. This may lead to reliability issues with the transport of the recording material in printers and copying machines.

There is hence a need for polyester film based recording material for ink and toner based printing which can be produced via an in-line coating production process and whose surface properties do match closely to wood based printing paper such as plain paper, copy paper or offset paper.

### SUMMARY OF INVENTION

Now it has been found that a printable layer on a side of a polyester containing film as defined in claim 1, can realize the objects of the present invention.

According to another aspect, the present invention includes a method of preparing a recording material of Claim 1. This method is defined in Claim 14.

Other features, elements, steps, characteristics and advantages of the present invention will become more apparent from the following detailed description of preferred embodiments of the present invention. Specific embodiments of the invention are also defined in the dependent claims.

### DESCRIPTION OF EMBODIMENTS

### A. Recording Material

The recording material of the present invention which is situated in the domain of synthetic papers, needs to have a high opacity in combination with and a low surface gloss. Based on a standard test method for specular gloss, ASTM D 523, both the 20° specular gloss and 60° specular gloss of the recorder material surface should be not more than 20, more preferably not more than 10, most preferably not more than 6. When the 20° and 60° gloss value, and preferably also the 85° gloss is below these values, a typical matte paper-like look of the surface of the synthetic paper is obtained and an excellent printability is achieved.

### A.1. Printable Subbing Layer

In order to achieve the above mentioned gloss values together with excellent printing characteristics, the recording material according to the invention should contain a printable subbing layer which is formed on a stretched polyester containing film. More preferably, the formed printable subbing layer comprises a water insoluble Cl-containing polymer, a water insoluble non-Cl containing polymer and a water soluble polymer containing an anionic group. The formed layer has a total coverage of 0.4 g/m² or more.

Without being bound by a theory, the low gloss and excellent printability of the formed printable subbing layer is due to the presence of a least 2 different polymer dispersions and a water soluble polymer in the coating solution. The polymer dispersions are compatible with each other in a coating solution but during drying the coating solution and additionally during stretching the obtained coated film, a low gloss appearance of the surface of the printable subbing layer is created that originates from local differences in layer thickness.

The first polymer dispersion is a dispersion of a Cl-containing polymer. The Cl-containing polymer, may be any polymer which contains a repeating unit including a Cl-atom, but is preferably an emulsion polymer prepared using a chlorinated monomer, such as vinyl chloride or vinylidene chloride. The second polymer is preferably a non-chloride containing polymer dispersion. The non-chloride containing polymer may be any polymer which does not contain a repeating unit having a Cl-atom, but is preferably an acrylic or urethane latex. Upon drying, these polymer dispersions provide a phase separation in the layer creating variations of thickness in the layer. This phase separation creates different phases providing more scattering and a matt layer can be obtained with a relative low layer coverage. Due to this low coverage, this printable subbing layer composition is very suitable to be applied in the production process of a stretched polyester containing film material. If the printable subbing layer is formed during the production process of the film, an additional layer coating in not required for achieving printability and matt surfaces. This makes the production process less complex and less costly.

Upon stretching, the dried printable subbing layer can even show lower gloss values. Indeed, stretching results in the creation of extra polyester containing surface. Polyester containing surface such as polyethylene terephthalate (PET) is hydrophobic and vinyl chloride or vinylidene chloride containing polymers tend to adsorb well to this hydrophobic surface. Hence, an additional de-mixing takes place during coating, drying and/or stretching which further reduced the gloss of the printable subbing layer.

Preferably, the content based on weight of the water insoluble non-Cl containing polymer is from 20 to 50 wt. %, with respect to the total amount of a water insoluble Cl-containing polymer, a water insoluble non-Cl containing polymer and a water soluble polymer containing an anionic group.

Preferably, the content based on weight of the water insoluble Cl-containing polymer is from 30 to 60 wt. %, with respect to the total amount of a water insoluble Cl-containing polymer, a water insoluble non-Cl containing polymer and a water soluble polymer containing an anionic group.

The water soluble polymer having an anionic group is preferably a polyvinyl based polymer containing anionic groups selected from the group consisting of carboxylic acid, sulfonic acid and phosphoric acid and/or salts thereof. A very suitable water soluble polymer is polystyrene sulfonic acid or polystyrene sulfonic acid sodium or ammonium salt. The product can be added in the acid form but due to a higher pH can be fully or partially converted in to a salt. Commercial trades are e.g. Versa TL grades (supplied by Nouryon) or polyNaSS PS grades (polystyrene sulfonic acid sodium salt), PolyNass MA series (Sodium methacrylate/Sodium β-styrenesulfonate copolymer), PolyNaSS HM series (2-Hydroxyethyl methacrylate/Sodium p-styrenesulfonate copolymer), PolyNASS ST series (Styrene/Sodium p-styrenesulfonate copolymer) supplied by TOSOH, or Poly(sodium-p-styrenesulfonate) supplied by Hangzhou Dayangchem. Such anionic polymer has the advantage that it provides anti-static properties to the printable subbing layer making this layer very suitable for toner printing applications.

Preferably, the content based on weight of water soluble polymer containing an anionic group is from 5 to 30 wt. %, more preferably from 10 to 30 wt. % with respect to the total amount of a water insoluble Cl-containing polymer, a water insoluble non-Cl containing polymer and a water soluble polymer containing an anionic group.

In order to increase the handling in the final application, and to guarantee an excellent transport in printing devices and copiers, the surface of the printable subbing layer which is not in contact with the surface of the polyester containing film should have a certain roughness. The roughness is commonly expressed as an arithmetic mean surface roughness (Ra). More particularly, the surface of the printable subbing layer which is not in contact with the surface of the polyester containing film, should have preferably an Ra-value of 0.1 μm or more, more preferably 0.3 μm or more, most preferably 0.4 μm or more. Also, a sufficient writeability is guaranteed when the Ra is 0.1 μm or more.

To further improve feedability in copiers and printing devices and make the surface of the printable subbing layer on a polyester containing film approaching the look and feel of copy paper, the printable subbing layer according to the invention may contain particles, also called matting particles.

The matting particles to be contained in the printable subbing layer may be inorganic particles such as titanium oxide, barium sulfate, calcium carbonate, calcium sulfate, silica, alumina, talc, kaolin, clay, calcium phosphate, mica, hectorite, zirconia, tungsten oxide, lithium fluoride, calcium fluoride and the like, organic polymer particles such as polystyrene, polyacrylic, melamine, benzoguanamine, silicone resin. These may be used in combination.

The average particle diameter of the matting particles is preferably more than 0.50 μm, more preferably 1 μm or more, and most preferably 2 μm or more. By setting the average particle diameter of the particles to the above range, there is a tendency that sufficient smoothness can be imparted. The upper limit of the average particle diameter of the particles is usually 15 μm or less, preferably 12 μm or less, more preferably 10 μm or less, and even more preferably 8 μm or less. By setting the average particle diameter to the above range, there is a tendency that the film surface does not become excessively rough.

The matting particles having a particle size ratio (longer diameter/shorter diameter) of 1.0-1.2, and the standard deviation of particle size of not more than 0.5 are particularly preferable. Matting particles satisfying these requirements include spherical silica particles, spherical silicone resin particles, spherical crosslinked polystyrene particles, spherical crosslinked acrylic particles, spherical or cubic calcium carbonate particles, calcium phosphate particles.

The presence of matting particles having an average particle diameter as described above lead to 85-degree specular gloss values of the printable subbing layer surface of 15 or less, more preferably of 10 or less, most preferably of 5 or less. The lower the value of the 85-degree specular gloss, the more the recording material has the look and feel of copy paper.

The total coverage of the printable subbing layer is preferably 0.4 g/m² or more. The total coverage of the printable subbing layer is defined as the weight of the printable layer in g/m² after drying and can be determined by a weighing experiment. When the coverage of the printable subbing layer is less than 0.4 g/m², the adhesion to the polyester film is not sufficient, and the matting particles cannot be sufficiently fixed in the printable subbing layer printable subbing layer, resulting in a low resistance in rubbing off of particles from the printable subbing layer. Conversely, when the total coverage of the printable subbing layer exceeds 5.0 g/m², the particles are more or less fully embedded in the resin of the printable subbing layer, and the surface irregularities and blocking resistance, indispensable for the handling property of the coated polyester film, may not be attained.

The antistatic capabilities of the printable subbing layer expressed by a surface resistance value are usually 1×10¹³Ω or less, preferably 1×10¹²Ω or less, more preferably 5×10¹¹Ω or less, even more preferably 1×10¹¹Ω or less, and particularly preferably 5×10¹⁰Ω or less. When within the above range, there is a tendency that films are prevented from being adhered to each other, and a film effective for preventing adhesion of dust is obtained. Accordingly, when such a film is used as a recording material to which a toner image can be suitably transferred by a method such as an electrophotographic method or a thermal transfer method, it is possible to prevent feeding of multiple sheets during the paper feeding of a copier or printer and further prevent sheets from adhering to each other during the handling and stacking of sheets.

### A.2. Bi-Axially Stretched Polyester Film

The polyester resin, which is a main component of the polyester film to be used for a substrate in the present invention, comprises a polyester obtained by polycondensation of a dicarboxylic acid, such as terephthalic acid, isophthalic acid, naphthalene dicarboxylic acid and the like or an ester thereof, and glycol, such as ethylene glycol, diethylene glycol, 1,4-butanediol, 1,6-hexamethylene glycol, neopentyl glycol and the like.

The polyester may also be prepared via ring opening polymerisation of a cyclic ester compound such as caprolactone, valerolactone, lactide, etc. . . . or can be prepared from a hydroxyl carboxylic acid such as hydroxybutyric acid or lactic acid.

The polyester resin may contain copolymerizable aromatic, aliphatic or alicyclic dicarboxylic acid and aromatic, aliphatic or alicyclic glycol as components.

Such polyester resin can be produced by polycondensation of aromatic dicarboxylic acid and glycol after esterification, polycondensation of aromatic dicarboxylic acid alkyl ester and glycol after transesterification, polycondensation of aromatic dicarboxylic acid diglycol ester, or by other known method.

Examples of the polyester resin include thermoplastic polyester resin such as polyethylene terephthalate, polybutylene terephthalate, polyethylene-2,6-naphthalate, polyethylene naphthalate (PEN), (co)polyesters based on cyclohexyldimethanol (CHDM) (PETG), (co)polyesters based on 2,5-furandicarboxylic acid (FDCA) (PEF), co-polyesters based on isosorbide, polycaprolactone (PCL), polybutylene adipate terephthalate (PBAT), polyhydroxyalkanoate (PHA) such as polyhydroxybutyrate (PHB), and polylactic acid (PLA). The polyester may be a homopolymer, or contain a heterologous polyester resin, or a copolymer comprising a third component. In any case, a polyester comprising ethylene terephthalate, butylene terephthalate, ethylene-2,6-naphthalate unit in a proportion of not less than 70 mole percent, preferably not less than 80 mole percent, more preferably not less than 90 mole percent, is preferable. Of these, polyethylene terephthalate is most preferable.

The polyester film to be used in the present invention is particularly preferably a bi-axially oriented film from the practical aspect of strength, stiffness and the ease of handling.

The polyester film to be used in the present invention may have a monolayer structure or a multilayer structure. The polyester film has an optical density showing the opacity of not less than 0.3, preferably 0.3-4.0, particularly preferably 0.5-3.0. When the optical density is less than 0.3, any printing on the surface of the coated polyester film obtained from such film becomes unpreferably illegible and unclear. When the optical density is not more than 4.0, more superior legibility can be expected.

The optical density within the above-mentioned range can be achieved without particular limitation by any method. For example, it is achieved by adding, to a polyester resin, a polyester incompatible compound such as inorganic particles or a thermoplastic resin incompatible with the polyester resin. With a polyester incompatible compound is meant a compound being immiscible with polyester and leading to a heterogenous mixture. When inorganic particles are added, the content thereof is preferably 4-35 wt. %, particularly preferably 6-25 wt. %, of the polyester produced. When an incompatible thermoplastic resin is added, its content is preferably 5-35 wt. %, particularly preferably 8-28 wt. %, of the polyester. When inorganic particles and a thermoplastic resin incompatible with the polyester resin are used in combination, the total amount thereof is preferably not more than 40 wt. % of the polyester film, from the aspects of film strength, stiffness and stability during film forming.

While the inorganic particles to be used are not subject to any particular limitation, those having an average particle size of 0.1-4.0 μm, particularly preferably 0.3-1.5 μm, are preferable. The inorganic particles are exemplified by white pigments such as titanium oxide, barium sulfate, calcium carbonate, zinc sulfide, which may be used in combination upon mixing. Furthermore, inorganic particles, such as silica, alumina, talc, kaolin, clay, calcium phosphate, mica, hectorite, zirconia, tungsten oxide, lithium fluoride, calcium fluoride, calcium sulfate and the like, which are generally used for films, may be concurrently used.

While the thermoplastic resin incompatible with a polyester resin is not subject to any particular limitation, polyolefin resin such as polystyrene resin, polyethylene resin, polypropylene resin, polymethylpentene resin, acrylic resin, styrene acrylonitrile copolymer, phenoxy resin, polyphenylene oxide resin, polycarbonate resin with a polyethylene terephthalate resin. Preferably, a styrene acrylonitrile copolymer is used as the polyester incompatible compound. These thermoplastic resins may be used in a mixture and may be modified. They can also be used concurrently with the above-mentioned inorganic particles. Where necessary, various optical brightening agents (OBA's) may be added. In particular, the following optical brighteners are preferred: OB1 optical brightener, i.e. CAS registry number 1533-45-5 or OB optical brightener, i.e. CAS registry number 7128-64-5.

The polyester film to be used in the present invention is preferably a porous polyester film having an apparent density of 0.3-1.3 g/cm³.

A porous polyester film having a ratio of the number of voids therein to the film thickness (hereinafter to be abbreviated as a void ratio) of not less than 0.20 void/μm, preferably not less than 0.25 void/μm, more preferably not less than 0.30 void/μm, is preferable for both the weight of the sheet and the optical density of the sheet. A polyester film obtained from such film coated with the printable subbing layer according to the invention is superior in clearness of print, foldability and ease of handling during printing. As used herein, the void to thickness ratio [void/μm]can be defined by the formula: void to thickness ratio [l/μm] is defined as the number of voids in the film thickness direction [l] divided by the film thickness [μm].

The upper limit of the void-to-thickness ratio is preferably 0.80 void/μm, more preferably 0.55 void/μm, in view of the void forming efficiency. The void-to-thickness ratio can be adjusted to fall within the above-mentioned range by changing the amount and the kind of incompatible thermoplastic resin or inorganic particles to be added, viscosity thereof and the like. The void-to-thickness ratio can be also adjusted by changing the shape of a screw of an extruder, setting a static mixer in the flow path of molten resin and the like.

Such porous polyester film is particularly useful because the opacity can be further improved by scattering of the light that occurs in the interface between fine voids in the film and matrix polyester, which improved opacity in turn reduces the amount of the aforementioned inorganic particles to be added. In addition, the presence of fine voids makes the substrate film itself lightweight, making handling easy and providing a greater economic effect in cutting costs of starting materials and transportation.

The obtained microporous polyester film has a thickness of preferably 5-300 μm. Particularly, a microporous polyester film having a void-to-thickness ratio of not less than 0.20 void/μm preferably has a thickness of 20-300 μm, more preferably 40-250 μm.

### B. Production Method

Bi-axially stretched polyester film can be produced by any method which includes kneading polyester pellets or granules followed by a film forming step such as extrusion and subsequently stretching the extruded film longitudinally and optionally transversally (or in the cross direction [MD]). A suitable method of producing bi-axially stretched polyester film and more specifically bi-axially stretched PET-film is described in GN 838 708 which is hereby incorporated by reference.

The porous polyester film as described in § A.2. can be obtained by any known method comprising kneading a polyester resin, which is a matrix, with a thermoplastic resin incompatible with the polyester resin or with inorganic particles, and stretching the obtained sheet, comprising the incompatible resin or inorganic particles dispersed in a fine particle state in the polyester resin, at least in a mono-axial direction, thereby forming voids around the aforementioned incompatible resin particulates or inorganic particles, or by other method.

The polyester film, according to the present invention, can be realized by a process for preparing a micro-voided bi-axially stretched film comprising the steps of: i) mixing at least one linear polyester having monomer components consisting essentially of at least one aromatic dicarboxylic acid and at least one aliphatic diol and a polyester incompatible compound such as inorganic particles or an thermoplastic resin and optionally at least one ingredient from the group of ingredients consisting of inorganic opacifying pigments, whitening agents, UV-absorbers, light stabilizers, antioxidants and flame retardants in a kneader or an extruder, ii) forming the mixture produced in step i) in a thick film followed by quenching to room temperature; iii) longitudinally stretching the thick film at a stretching tension of >4 N/mm² to at least twice the initial length; and iv) transversally stretching the longitudinally stretched film from step (iii) at a stretching tension of >4 N/mm² to at least twice the initial length.

In a preferred embodiment of the invention, the polyester containing film is a micro-voided bi-axially stretched film containing polyethylene terephthalic acid and styrene acrylonitrile. This polyester containing film is preferably produced according to the process described in pages 15 to 16 from WO08040670.

The longitudinal stretching operations known in the art to produce mono-axially oriented polyester film may be used. For instance, the combined film layers are passed between a pair of infrared heaters which heats the layers to a temperature above the glass transition temperature of the polyester (about 80° C. for polyethylene terephthalate) in the region where the stretching occurs. In the case of polyethylene terephthalate, the longitudinal stretching is generally carried out at from about 80° C. to about 130° C. During longitudinal stretching opacity is realized as a result of the voids produced in the film extending longitudinally from each particle of thermoplastic polymer incompatible with polyester of each inorganic particle.

Transverse stretching is carried out at an angle substantially 90° to the direction of longitudinal stretching, with the angle being typically between about 70° and 90°. For transverse stretching use is generally made of an appropriate frame, clamping both edges of the film and then stretching toward the two sides and simultaneously heating the combined layers with the printable subbing layer thereon by, for example, passing through hot air heaters which heat the film. In the case of polyethylene terephthalate and its copolymers, the transverse stretching is carried out at from about 80 to about 170° C., with from about 85 to about 150° being preferred. The transverse stretching of the film causes the voids, if present, to extend transversely.

The production of the bi-axially stretched polyester film, according to the present invention, is preferably produced by longitudinally stretching the thick film at a stretching tension>2.5 N/mm². After optional intermediate quenching the longitudinal stretching is followed by transverse stretching at an angle substantially 90° to the first stretching process to at least twice the initial length at a stretching tension of >2.5 N/mm², with a stretching tension of >4.0 N/mm2 being preferred. The realizable stretching tension increases with decreasing stretching temperature.

Longitudinal and transverse stretching may be performed simultaneously e.g. with an apparatus produced by Bruckner.

The production process may further comprise, as a further step, a thermal fixation step to counter shrinkage.

The stretching ratio for longitudinal stretching is preferably between about 2 and about 6, with between about 2.5 and about 5 being preferred and between 3 and 4 being particularly preferred. The higher the stretching ratio, the higher is the opacity if voids are present.

Transverse stretching ratio is preferably in the range of from about 2 to about 6, with a range of 2.5 to about 5 being preferred and a range of from about 3 to about 4 being particularly preferred.

The bi-axially stretched film may finally pass through a second set of hot air heaters which blow hot air at a temperature of between 14° and 240° C. onto the film layers to heat-set the printable subbing layer by thermofixation.

The printable subbing layer may be formed by applying a coating solution, comprising a water insoluble Cl-containing polymer, a water insoluble non-Cl containing polymer and a water soluble polymer containing an anionic group, to the surface of a polyester film, which is a substrate, or by laminating a mixture of a water insoluble Cl-containing polymer, a water insoluble non-Cl containing polymer and a water soluble polymer containing an anionic group on a polyester film, which is a substrate, by co-extrusion, or by other method.

To improve the adhesion between the polyester film, which is a substrate, and the printable subbing layer, moreover, the film may be subjected to a surface treatment in advance. The surface treatment may be, for example, a corona discharge treatment, a plasma discharge treatment, an active energy beam irradiation, such as ultraviolet (UV) irradiation treatment, electron beam (EB) irradiation treatment and the like, a flame treatment, or vapor deposition such as PVD or CVD.

As a method for forming a printable subbing layer, a method comprising of the application of a coating solution containing a Cl containing water insoluble polymer, a water insoluble non-Cl containing polymer and a water soluble polymer containing an anionic group to the surface of a polyester film is preferable. The coating solution has a pH of preferably 5.5 to 10.0. When the liquid temperature or pH of the coating solution is outside the above-mentioned range, matting particles in the coating solution easily agglomerate, which gives rise to lower productivity due to the clogging of filter in a coating solution circulation system, decreased resistance to rubbing off of particles from the printable subbing layer and lower time-course stability of the coating solution. It is desirable to filter the coating solution before coating the above-mentioned coating solution, using a filter such as wire-mesh screen, bag type filter, bobbin winder type filter, cartridge type filter and the like, thereby to remove large matting particles that exceed the above-mentioned range of preferable average particle size.

The above-mentioned coating method may be a typical method such as roll coating (e.g., gravure coating, reverse coating, kiss coating, reverse kiss coating and the like), bar coating, air knife method, blade coating, comma coating (roll knife coating), curtain coating, spraying, dipping and the like.

The printable subbing layer may be applied to the surface of an un-oriented polyester film in advance, may be applied to the surface of a mono-axially oriented or longitudinally stretched polyester film, and the film may be further stretched in the direction forming a right angle with the direction of the first orientation, may be applied to the surface of a bi-axially oriented polyester film or may be applied in a different manner. Preferably, the recording material according to the invention is made via a method comprising applying the coating of the coating solution comprising the water insoluble Cl-containing polymer, the water insoluble non-Cl containing polymer and the water soluble polymer having an anionic group to the surface of a mono-axially oriented polyester film after drying and after longitudinally stretching, stretching in the direction forming a right angle with the direction of the first orientation (traverse stretching).

Preferably, the recording material according to the invention is prepared according to following steps:
a) longitudinally stretching a polyester sheet or web; and
b) applying a coating composition comprising a water insoluble Cl-containing polymer, a water insoluble non-Cl containing polymer and a water soluble polymer containing an anionic group on a surface of the sheet or web obtained in a); and
c) drying the coating composition such as to form a printable subbing layer; and
d) transversally stretching the coated polyester sheet.

### C. Examples

### C.1. Materials

All materials were supplied by Acros or Aldrich unless otherwise specified.
PET/SAN is a master batch of polyethylene terephthalate and styrene acrylonitrile mixture from Trinseo Netherlands BV
IPA-PET is a copolymer of monoethylene glycol, terephthalic acid and isophthalic acid prepared via melt condensation.
PET/CaCO₃ is a master batch of polyethylene terephthalate and CaCO₃ mixture from Setas̨ Kimya Sanayi A.S̨ with tradename MasterSet PES 1345 DR
TiO2-PET is a TiO2-polyester master batch supplied by Sukano with tradename Sukano S204HD-C
Uvitex is a PET/4% optical brightener from Sukano with tradename SUKANO TA16 10 MB01
Kieselsol 100F is a colloidal silica from HC Starck
Syloid 72 disp a 20 wt. % aqueous dispersion of Syloid 72 (a gel silica supplied by WF Grace) having a particle size from 4.5 to 5.7 μm
Mersolat H40 is a 3.7 wt. % aqueous solution of a sulphonated surfactant supplied by Lanxess
Tividasol is a 2.5% aqueous solution of Tivida FL2500 (weight ratio Fluor surfactant/water/methoxy propanol/ethanol=2.5/67.86/4.64/25) and is obtained by diluting Tivida FL2500 with water/EtOH 73/27.
Neocryl XK160 is 42.5 wt. % aqueous dispersion of a polyacrylate latex supplied by Covestro
Versa TL77 is a Polystyrene sulphonic acid sodium salt from Nouryon
Diofan A675 is a vinylidene chloride-itaconic acid-methacrylic acid copolymer and is prepared as follows: In a pressure reactor of 800 ml following components were added:
524.27 g of demi-water
2.97 g of Mersolat H40
4.29 g of Itaconic acid supplied by Unipex Benelux NV
2.72 mg Iron(II)nitrate·H2O dissolved in 16.58 g. of water

Subsequently a first monomer fraction (i.e. 20% of the total amount) was added within 5 minutes, i.e. 37.73 g of vinylidene chloride and 4.3 g of methylacrylate.

Subsequently, a first initiator fraction was added (i.e. 75% of the total amount), i.e. 19.96 g of a 2% aqueous solution of potassium persulfate 11.39 g of a 3.5 wt. % aqueous solution of potassium metabisulfite Both solutions were added separately, first the persulfate and then the metabisulfite. The reactor was heated to 50° C. within 30 minutes and stirred at 150 RPM.

During the heating the polymerization starts and becomes exothermic, consequently the reactor needs to be cooled to keep the temperature at 50° C. After the nucleation of the latex was finished, the dosing of the remaining monomer fraction was started, i.e. 150.94 g vinylidene chloride and 17.2 g of methylacrylate. The monomer added dosed as a mixture during 2 hours.

After the dosing of monomer was finished 6.65 g. of the potassium persulfate solution (2% in water) and 3.75 g. of the potassium metabisulfite (3.5% in water) was added during 6 minutes. Then the reactor was stirred still for 1 hour and subsequently cooled to room temperature. Afterwards the residual monomer was removed by vacuum distillation.
Daran SL159 is 54% aqueous dispersion of vinylidene chloride-methacrylic acid copolymer from Borchers.
Unifon is a 14.46 wt. % polystyrene sulfonic acid sodium salt solution in demi-water and is prepared as follows: 234 kg of Polystyrene (Himer ST95 supplied by Mitsui) was stirred in 1210 kg of concentrated Sulphuric acid. The reactor was heated to 85° C. The reaction is exothermic and the temperature is allowed to reach 110° C., then the mixture was further heated to 120° C. and stirred during 90 minutes. Subsequently the reaction mixture was cooled to 20° C. For extraction another reactor was filled with 2330 L of demi-water and put under nitrogen by 3 times applying vacuum and filling again with nitrogen. 1120 L of 1-pentanol was added to the demi water. The reactor was cooled to 0° C. The reaction mixture was then added to the water/pentanol mixture, while keeping the temperature below 35° C. The reactor which contained the reaction mixture was rinsed with 300 L of demi-water. The reactor was subsequently further cooled to 20° C. The stirring was stopped so that the liquid-liquid separation could occur during 90 minutes. The lower part was removed to another vessel and the separation tube is rinsed with 50 L of demi-water. The PSS is in the acid form and will stay in the pentanol phase. The reactor for neutralizing the polystyrene sulfonic acid was then put to 0° C. This reactor was first filled with a sodium hydroxide solution and then the pentanol phase was added. The reaction mixture in pentanol was neutralised by addition of 360 L of sodium hydroxide (30 wt. % in water) during 30° C., while keeping the temperature below 40° C. The pH was measured. In case the pH is below 6, more NaOH (30 wt. %) was added in portions of 5 L until the pH>6. Subsequently the reactor content was transferred to another reactor for removing the pentanol under vacuum. The pentanol was distilled off at atmospheric pressure at a high rotation speed. The temperature is increasing from 86 to 102° C. Then the reactor was cooled to 60° C. at low stirring speed. The pH is adjusted to 7.0-7.5. When too acidic NaOH (15 wt. % in water) was added, when too basic H₂SO₄. aq 6N is added. Then 984 L of methanol and 97 L of deionize water was added. The reactor was cooled to 20° C. The mixture was put on a Cogeim filter which was put under an overpressure of 1.5 bar Nitrogen in order to remove the Na₂SO₄ salt. The diluted PSS was filtered to a different vessel and the reactor was flushed with 70 L of methanol, which was also filtered to the reactor where the PSS is present. The 500 L of demi-water of 50° C. was added and mixed for 15 minutes on the filter containing the sodium sulfate salt. The filtrate was put to the waste stream. Subsequently the methanol was distilled off. As a biocide, Proxel K (supplied by Prom Chemical UK) is added in an amount of 2 L/1000 L). The pH was adjusted to a value of 7.0 to 8.0 by addition of sodium hydroxide 15% in water or sulfuric acid at 6N. The solids content was adjusted to 17 gram/100 ml.
p-DADMAC is an aqueous 40% solution of polydiallyl dimethyl ammonium chloride supplied by Katpol Chemie GmbH
PLM150 is an aqueous 20 wt. % polymeric matting particle dispersion containing p-MMA and stearyl methacrylate having an average particle size of 7 to 8 μm.
PET-film 1: Is a mono-axially stretched polyethylene terephthalate (PET), that was obtained by longitudinal stretching of a sheet of PET produced on a pilot installation with extrusion.

The PET was prepared as follows: In the first step of the production process terephthalic acid, isophthalic acid, ethylene glycol and triethylfosfate were thoroughly mixed to form a dispersion in ethylene glycol.

This dispersion was esterified into short pre-polymer chains in multiple esterification reactors placed in series at approximately 270° C. and at a slight overpressure. During the esterification reaction, water was split off and removed from the reaction via distillation.

After the esterification process, the pre-polymer was pumped to multiple polycondensation reactors, placed in series. The pre-polymer reacted in these reactors at approximately 280° C. and at negative pressure to achieve the desired chain length or degree of polymerization linked with a viscosity value between 0558 and 0.582 dL/g. During the polycondensation, ethylene glycol was released and extracted from the production process. It was then condensed and reused in the production process. When the desired chain length of about 80 monomeric units was achieved, the melt flow was partly diverted to a nozzle where polymer wires were sprayed in a water bed. The cooled polymer wires were then cut, dried and finally blown into a silo as granules. These PET granules served as raw material for the PET-extrusion.

Before starting the extrusion, the PET granules were dried in an oven for 3 hours at 135° C. This is done under a vacuum of 16 mbara. The PET granules were heated in a pilot extrusion machine at a temperature between 280° C. and 285° C. The extrusion speed was 1.5 m/min and the width of the extruded film was 430 mm. The extruded film was cooled by contact with a cooling roll at 20-35° C., finally a film having a thickness of 1100 μm was obtained.

In a following step, this film was stretched longitudinally by a factor of 3.3 at a temperature of 150° C. applying stretching forces from 6 to 8 N/mm² using heated rollers having different rotation speeds. After the stretching step, the film was cooled with water having a temperature of 15° C. A mono-axially stretched PET film, having a width of 390 mm and a thickness of 350 to 450 μm was thus obtained.
PET-film 2: Is a micro-voided, longitudinally stretched PET/SAN (Polyethylene terephthalate/Styrene-Acrylonitrile) film having a thickness of 350-450 μm. The extrusion and longitudinally stretching of the film was performed in the same way as for PET-film 1 except that following mixture was dried and added to the extruder: 37.5 wt. % of PET/SAN, 54 wt. % of IPA PET, 4.5 wt. % of PET granules, 3 wt. % of TiO2-PET and 0.9 wt. % of Uvitex.
PET-film 3: Is a micro-voided, longitudinally stretched PET/CaCO3 film having a thickness of 350 to 450 μm. The extrusion and longitudinally stretching of the film was performed in the same way as for PET-film 1 except that following mixture was dried and added to the extruder: 16.67 wt. % of PET/CaCO3 and 83.33 wt. % of PET granules.

### C.2. Measuring Methods

### C.2.1. Printable Subbing Layer (PSL) Preparation on PET Containing Film Sheets.

The printable subbing layer was prepared by coating a printable subbing layer coating composition on a mono-axially stretched PET containing film. The printable subbing layer was coated by means of a coating table (Braive Instruments). The coating table was preheated to a temperature of 30° C. or 50° C. prior to the coating. The wet thickness of the coating was controlled by the coating bar, which was set to the appropriate thickness such that a required coverage (g/m² of solids) was obtained. The coating was allowed to stand for approximately 3 minutes until the coating was dry. After the drying process, the PET containing film and the printable subbing layer thereon, was stretched on a pilot stretching installation with a factor of 3.3 to 3.5.

### C.2.2. Printable Subbing Layer (PSL) Preparation on a PET Film Web

The printable subbing layer was prepared by coating a printable subbing layer coating composition on a web of mono-axially stretched PET film 1, 2 or 3. The printable subbing layer was coated by means of coating knife at a wet thickness of 13 μm. The web was pre-heated to a temperature of 50° C. prior to the coating. The wet thickness of the coating was controlled by measuring the weight loss off the coating solution in the coating device, which was set to the appropriate thickness such that a required coverage (g/m² of solids) was obtained. The coating was dried at 70° C. After the drying process, the PET film 1, 2 or 3 and the printable subbing layer thereon were transversally stretched in a pilot stretcher from Bruckner as follows: The transverse stretching was carried out at an angle of 90° with respect to the direction of the longitudinal stretching. Therefore, coated film samples were cut into sheets of 240 mm×1550 mm and fixed in the stretcher with clams at each side. The sheets were then heated at following temperatures: coated PET-film 1 at 120° C., coated PET-film 2 at 100° C. and coated PET-film 3 at 90° C. Stretching forces were applied such that a stretching with a factor of 3.3 to 3.5 is obtained.

### C.2.3. Gloss Measurements

The specular gloss of the surface of the printable subbing layer, was measured according to ASTM D 523 by means of a Hach Lange REFO 3 at the 3 angles: 20°, 60° and 85°.

C.2.4. Resistance to Rubbing Off of Matting Particles from the PSL

The resistance to rubbing off of the matting particles from the printable subbing layer was measured as follows.

The PET containing films coated with a printable subbing layer were cut in round disks having a diameter of 120 mm and rubbed 20 times with a black felt disk having a diameter of 58 nm in an Usomètre Lhomargy model US.01.

The rub-off of the matting particles takes became visible as a deposited ring onto the black felt disk. The deposit was evaluated visually and ranked according to the criteria in Table 1.

TABLE 1

| Visual evaluation | Ranking |
|---|---|
| No deposition | 0 |
| Small deposition, less than 25% | 1 |
| coverage of the ring surface | |
| Medium deposition, less than | 2 |
| 50% coverage of the ring surface | |
| Strong deposition, more than | 3 |
| 50% coverage of the ring surface | |

### C.2.5. Measurement of the Arithmetic Mean Surface Roughness (Ra)

The definition of the arithmetic mean surface roughness RA, is to be found in ISO 4287:1997 Geometrical Product Specifications (GPS)—Surface texture: Profile method—Terms, definitions and surface texture parameters.

Before measurement, all recording material samples were covered with an Au coating of 45 nm by sputtering.

The Ra of the surface of the printable subbing layer was measured using a non-contact surface/layer Wyko NT3300 optical profiler (see ISO 25178-6:2010(en) Geometrical product specifications (GPS)—Surface texture: Areal—Part 6: Classification of methods for measuring surface texture). 2D-surface scans of the printable subbing layer were made at a magnification of 50 and a 0.5×FOV-lens. The Field-Of-View is 246 μm×187 μm, the Array size is 736×480, the Spatial Sampling is 334.33 nm, Optical Resolution is 0.55 μm and the Modulation Threshold 0.5%. The high pass wavelength cut-off is set to 80 μm. Processing the digital date included the use of a ‘soft-outlier-removement’.

To assure an acceptable feedability in printing equipment and copiers and a sufficient writeability, the Ra-value should be preferably above 0.1 μm.

### C.3. Printable Subbing Layers

In a first series, the requirement of the presence of a water insoluble Cl-containing polymer, a water insoluble non-Cl containing polymer and a water soluble polymer containing an anionic group in order to achieve matt surfaces is demonstrated.

Five coating compositions were prepared and four of them were coated on the PET-film 1 and stretched according the method described in § C.2.1. The temperature of the PET film during coating was set to 30° C. One inventive printable subbing layer INVPSL-1 and 3 comparative printable subbing layers COMPPSL-1 to COMPPSL-3 onto a PET-film 1 were obtained. The compositions of the printable subbing layers are listed in Table 2. The fifth coating composition was characterised in that the Unifon was replaced by a water soluble polymer containing a cationic group (see Table 2. However, this coating composition could not be coated as it already flocculated completely during the preparation. The gloss of the coated printable subbing layer is measured according to § 0.2.3., and the values are listed in Table 2.

TABLE 2

| Compounds | INVPSL- | COMP | COMPP | COMP | COMPP |
|---|---|---|---|---|---|
| (mg/m²) | 1 | PSL-1 | SL-2 | PSL-3 | SL-4* |
| Diofan A675 | 455 | 455 | 455 | 0 | 428.6 |
| Neocryl XK- | 386 | 386 | 0 | 386 | 364.3 |
| 160 | | | | | |
| Unifon | 195 | 0 | 195 | 195 | 0 |
| Tividasol | 2 | 2 | 2 | 2 | 1.44 |
| p-DADMAC | 0 | 0 | 0 | 0 | 183.8 |
| PLM150 | 6 | 6 | 6 | 6 | 0 |
| Gloss 20° | 0.65 | 125.40 | 12.90 | 1.90 | N.A. |
| Gloss 60° | 4.10 | 132.70 | 24.85 | 11.55 | N.A. |
| Gloss 85° | 19.35 | 97.70 | 4.20 | 71.10 | N.A. |

*theoretical layer composition if the coating composition would have been coated and dried.

From Table 2 it can be concluded that the combination of a water insoluble Cl-containing polymer, a water insoluble non-Cl containing polymer and a water soluble polymer containing an anionic group is required to obtain matt printable subbing layers, giving the surface of the PET-films a paper look. From the above it can further be concluded that replacing the anionic group by a cationic group, does not result in stable coating solutions which can be coated on PET films.

In a second series, the minimal layer thickness to achieve matt printable subbing layers is demonstrated.

One coating solution was prepared and coated on different thicknesses on the PET-film 1 (at a temperature of 5000) and stretched according § 0.2.1. The composition of the obtained printable subbing layers, together with the total amount of the solid components after stretching, is listed in Table 3. The gloss of the coated printable subbing layer is measured according to § 0.2.3. and the values are listed in Table 3.

TABLE 3

| Compounds | COMPP | COMPP | INVPSL- | INVPSL- | INVPSL- | INVPSL- |
|---|---|---|---|---|---|---|
| (mg/m²) | SL-5 | SL-6 | 2 | 3 | 4 | 5 |
| Diofan A675 | 11 | 43 | 214 | 429 | 857 | 1286 |
| Neocryl XK- | 9 | 36 | 182 | 364 | 729 | 1093 |
| 160 | | | | | | |
| Unifon | 4.6 | 18 | 92 | 184 | 368 | 552 |
| Mersolat | 0.04 | 0.14 | 0.7 | 1.4 | 2.9 | 4.3 |
| H40 | | | | | | |
| Total solids | 0.024 | 0.098 | 0.489 | 0.978 | 1.956 | 2.934 |
| (g/m²) | | | | | | |
| Gloss 20° | N.A.** | 19.37 | 0.60 | 0.50 | 0.40 | 0.47 |
| Gloss 60° | N.A.** | 38.53 | 3.37 | 2.77 | 2.43 | 2.33 |
| Gloss 85° | N.A.** | 92.00 | 49.00 | 28.90 | 26.97 | 29.13 |
| Ra (μm) | N.A.** | 0.031 | 0.145 | 0.389 | 0.444 | 0.444 |

**not measurable due to non-uniform coated PSL.

From the results in Table 3 it can be concluded that the total coverage of the printable subbing layer should be equal to 0.4 g/m² or more to achieve gloss values at 200 and 60° below 10 and an Ra-value above 0.1 μm.

In a third series, the minimal layer thickness to achieve printable subbing layers wherein matting particles in the PSL, do not get rubbed off, is demonstrated.

One coating solution with matting particles was prepared and coated on different thicknesses on the PET-film 1 (at a temperature of 50° C.) and stretched according § C.2.1. The composition of the obtained printable subbing layers, together with the total amount of the solid components per m² after stretching, is listed in Table 4. The gloss and the resistance against rubbing off the matting particles in the printable subbing layer is measured according to § C.2.3. and § C.2.4. respectively.

TABLE 4

| Compounds | COMP- | COMP- | INV- | INV- | INV- | INV- |
|---|---|---|---|---|---|---|
| (mg/m²) | PSL-7 | PSL-8 | PSL-6 | PSL-7 | PSL-8 | PSL-9 |
| Syloid 72 | 3.0 | 12 | 59 | 118 | 237 | 355 |
| disp | | | | | | |
| Diofan A675 | 11 | 43 | 214 | 429 | 857 | 1286 |
| Neocryl XK- | 9 | 36 | 182 | 364 | 729 | 1093 |
| 160 | | | | | | |
| Unifon | 4.6 | 18 | 92 | 184 | 368 | 552 |
| Mersolat | 0.04 | 0.14 | 0.7 | 1.4 | 2.9 | 4.3 |
| H40 | | | | | | |
| PLM150 | 0.14 | 0.6 | 2.9 | 5.7 | 11 | 17 |
| Total solids | 0.028 | 0.110 | 0.551 | 1.102 | 2.204 | 3.306 |
| (g/m²) | | | | | | |
| Gloss 20° | N.A. | 61.00 | 5.87 | 3.97 | 3.60 | 3.70 |
| Gloss 60° | N.A. | 69.00 | 5.00 | 2.57 | 2.93 | 3.07 |
| Gloss 85° | N.A. | 69.00 | 5.00 | 2.57 | 2.93 | 3.07 |
| Ra (μm) | N.A. | 0.046 | 0.645 | 1.490 | 1.334 | 1.523 |
| Resistance | N.A. | 3 | 1 | 0 | 1 | 1 |
| to rubbing | | | | | | |
| off matting | | | | | | |
| particles | | | | | | |

** not measurable due to non-uniform coated PSL

From the results in Table 4 it can be concluded that the total coverage of the printable subbing layer should be 0.4 g/m² or more to achieve 20° and 60° gloss values below 10 and to achieve 85° gloss values of 5 or less making the surface of the recording material look like the surface of wood based copy paper. From Table 4 it also follows that from a coverage of 0.4 g/m² or more, an acceptable resistance in rubbing off matting particles from the printable subbing layer is obtained.

In a fourth series, it is demonstrated that the inventive printable subbing layers result in matt surfaces on different PET containing films.

Coating solutions were prepared and coated on different mono-axially stretched PET containing films and subsequently stretched in transversal direction as described in § C.2.2. The composition of the printable subbing layers are listed in Table 5. The method of coating and stretching and the results of the gloss measurements according to § C.2.3. are listed in Table 6.

TABLE 5

| Compounds | | | |
|---|---|---|---|
| (mg/m²) | INVPSL-10 | INVPSL-11 | INVPSL-12 |
| Syloid 72 disp | 118 | 102.5 | 103 |
| Diofan A675 | 429 | 371 | — |
| Daran SL159 | — | — | 371 |
| Neocryl XK-160 | 364 | 315.73 | 315.73 |
| Unifon | 184 | 159 | 159 |
| Mersolat H40 | 1.4 | 1.0 | 1.0 |
| Total solids (g/m²) | 1.096 | 0.95 | 0.95 |

TABLE 6

| | Printable | Preparation | Gloss | Gloss | Gloss |
|---|---|---|---|---|---|
| PET film | subbing layer | method | 20° | 60° | 85° |
| PET-film 1 | INVPSL-10 | § C.2.2. | 2.00 | 4.45 | 3.13 |
| PET-film 1 | INVPSL-11 | § C.2.1. | 3.30 | 7.45 | 3.05 |
| PET-film 1 | INVPSL-12 | § C.2.1. | 2.10 | 5.40 | 3.15 |
| PET-film 2 | INVPSL-10 | § C.2.2. | 8.57 | 8.97 | 10.37 |
| PET-film 3 | INVPSL-10 | § C.2.2. | 2.72 | 6.20 | 9.61 |

The results of Table 6 show that the composition of the printable subbing layer according to the invention gives matt printable layers on different PET containing films, including voids containing PET-films.

1-15. (canceled)

16. A recording material comprising a bi-axially stretched polyester containing film and a printable subbing layer formed on at least one surface of the film, wherein the printable subbing layer has a total coverage of 0.4 g/m² or more and 5.0 g/m² or less and comprises a water insoluble Cl-containing polymer, a water insoluble non-Cl containing polymer, and a water soluble polymer containing an anionic group.

17. The recording material of claim 16, wherein the amount of the water insoluble Cl-containing polymer is from 30 to 60 wt. %, the amount of a water insoluble non-Cl containing polymer is from 20 to 50 wt. %, and the water soluble polymer containing an anionic group is from 5 to 30 wt. % with respect to the total weight of the printable subbing layer.

18. The recording material of claim 16, wherein the surface of the printable subbing layer, which is not in contact with the polyester containing film, has an arithmetic mean roughness (Ra) of 0.1 μm or more.

19. The recording material of claim 17, wherein the surface of the printable subbing layer, which is not in contact with the polyester containing film, has an arithmetic mean roughness (Ra) of 0.1 μm or more.

20. The recording material of claim 16, wherein the printable subbing layer comprises matting particles having an average particle size from 2 to 10 μm.

21. The recording material of claim 20, wherein the gloss measured at an angle of 850 of a surface of the printable layer, situated opposed to the surface in contact with the polyester containing film, has a value of 5 or less.

22. The recording material of claim 19, wherein the printable subbing layer comprises matting particles having an average particle size from 2 to 10 μm.

23. The recording material of claim 16, wherein the printable subbing layer is formed by applying a coating solution containing a water insoluble Cl-containing polymer, a water insoluble non-Cl containing polymer, and a water soluble polymer containing an anionic group on a surface of the film, drying the applied coating solution, and subsequently stretching the film with a factor from 2 to 5.

24. The recording material of claim 16, wherein the polyester containing film has a thickness of 10 μm to 1000 μm and the polyester containing film comprises a polyester incompatible compound.

25. The recording material of claim 24, wherein the polyester incompatible compound is selected from the group consisting of a styrene acrylonitrile copolymer, a polystyrene resin, a polyethylene resin, a polypropylene resin, a polymethylpentene resin, an acrylic resin, a phenoxy resin, a polyphenylene oxide resin, a polycarbonate resin, titanium oxide, barium sulfate, calcium carbonate, silica, alumina, talc, kaolin, clay, calcium phosphate, mica, hectorite, zirconia, tungsten oxide, lithium fluoride, calcium fluoride, calcium sulfate, zinc sulfide, and combinations thereof.

26. The recording material of claim 24, wherein the polyester film comprises voids and has an apparent density from 0.3 to 1.3 g/cm³.

27. The recording material of claim 16, wherein the water insoluble non-Cl containing polymer is an acrylate or a urethane containing polymer.

28. The recording material of claim 19, wherein the water insoluble non-Cl containing polymer is an acrylate or a urethane containing polymer.

29. The recording material of claim 16, wherein the water soluble polymer is an anionic conductive polymer.

30. The recording material of claim 19, wherein the water soluble polymer is an anionic conductive polymer.

31. The recording material of claim 16, wherein the water soluble polymer is a polystyrene sulfonic acid.

32. The recording material of claim 16, wherein the water insoluble Cl-containing polymer is poly vinyl chloride or poly vinylidene chloride homo- or co-polymer.

33. The recording material of claim 24, wherein the water insoluble Cl-containing polymer is poly vinyl chloride or poly vinylidene chloride homo- or co-polymer.

34. A method of preparing a recording material as defined in claim 16 comprising following steps:
a) longitudinally stretching a polyester containing film;
b) applying a coating composition comprising a water insoluble Cl-containing polymer, a water insoluble non-Cl containing polymer, and a water soluble polymer containing an anionic group onto a surface of the longitudinally stretched film;
c) drying the coating composition; and
d) transversally stretching the coated polyester sheet at a temperature from 80° C. to 130° C.

35. The method of preparing a recording material of claim 34, wherein prior to step a) the polyester containing film was prepared by mixing a linear polyester having monomer components consisting essentially of at least one aromatic dicarboxylic acid and at least one aliphatic diol and a polyester incompatible compound such as inorganic particles or a thermoplastic resin in a kneader or an extruder followed by extruding the mixture such as to form a thick film followed by quenching to room temperature.
